(19) United States
(12) Patent Application Publication
(10) Pub. No.: US 2006/0250272 A1
(43) Pub. Date: Nov. 9, 2006

(54) Remotely operable vehicle disabling system

(76) Inventor: Soane R. Puamau, Richmond (CA)

Correspondence Address: ASHKAN NAJAFI, P.A., 6817 SOUTHPOINT PARKWAY, SUITE 2301, JACKSONVILLE, FL, 32216, US

(21) Appl. No.: 11/124,482

(22) Filed: May 9, 2005

(51) Int. Cl. G05D 1/00; G08C 19/00

(52) U.S. Cl. 340/825.69; 701/2

(57) ABSTRACT

A vehicle control system includes a first controller including a wireless mechanism for determining a vehicle identification number. A second controller includes wireless mechanisms for communicating with the first controller and for controlling a velocity of the targeted vehicle without restricting the braking and steering capabilities thereof. The system includes a service provider including a database containing authorization codes unique to vehicle identification numbers. A communications link transmits confidential data streams to the service provider. The communications link includes a wireless cellular telephone network. The system includes a request signal, an authorization signal, and a deactivation signal. The second controller sends the response signal to the first controller, which transmits the request signal to the service provider. An authorization signal is transmitted to the law enforcement officer. The first controller transmits the deactivation signal to the vehicle, causing the second controller to disable selected operating characteristics thereof.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to vehicle disabling systems and, more particularly, to a remotely operable vehicle disabling system for allowing law enforcement personnel to remotely disable a targeted vehicle.

2. Prior Art

The problem of reducing high-speed chases often associated with pursuing a traffic violator, a drunk driver, or a stolen vehicle, has received great attention within recent years and by numerous and widely varied approaches. The frustration with the consequences of dangerous high speed chases, many of which result in serious injuries, and often to innocent bystanders, has even engendered the use of a system commonly known as “stop sticks” that requires the police to get in front of the chased vehicle and place a line of spikes in its path. Aside from the clumsiness of this tactic and the obvious hazard to the police and public from the vehicle with flat tires hurling at them at a high rate of speed, new technology in tires has produced a line of tires that can run some fifty miles without air in them.

As is expected, the longer a chase takes, the greater are the chances that non-involved parties will become victims of the pursuit. As a result, law enforcement officials may need to terminate chase efforts because of danger to third parties and thus, permit criminals to escape apprehension. When such termination is not a viable choice, however, risks continue to accrue until the course of the chase is resolved. In view of the danger and potential injury to innocent third parties because of police chases, it is evident that a need is present for technology that can allow police personnel to apprehend such fleeing criminals without lengthy pursuits.

In some instances, the offender will actually pull over their vehicle at the first sign of a pursuing officer. However, even though the police have stopped a vehicle they are still subject to the serious risk that the operator can speed off again, often running them down or even shooting the officer, and escaping.

Accordingly, a need remains for a remotely operable vehicle disabling system in order to overcome the above noted shortcomings. The present invention satisfies such a need by providing a vehicle disabling system that is remotely operable, easy to use, and installable in new and existing motor vehicles. The timely use of such a system quickly terminates street and highway chases before they escalate into dangerous high-speed situations. Officers can also use the remotely operable vehicle disabling system to capture and restrain vehicles before suspects have a chance to flee.

### BRIEF SUMMARY OF THE INVENTION

In view of the foregoing background, it is therefore an object of the present invention to provide a remotely operable vehicle disabling system. These and other objects, features, and advantages of the invention are provided by a vehicle control system for allowing law enforcement personnel to remotely disable a targeted vehicle.

The vehicle control system includes a first controller housed within a law enforcement vehicle. Such a first controller includes a wireless mechanism for determining a vehicle identification number unique to the targeted vehicle when the targeted vehicle enters a predetermined proximity surrounding the first controller. The wireless mechanism generates and transmits a short range inquiry signal to the targeted vehicle for effectively requesting the vehicle identification number.

The first controller wireless mechanism preferably includes an internal power supply source, a processor electrically coupled to the internal power supply source, a user interface electrically coupled to the processor and a transceiver electrically coupled to the processor.

A second controller is housed within the targeted vehicle. Such a second controller includes a wireless mechanism for effectively communicating with the first controller and further includes a mechanism for controlling a velocity of the targeted vehicle advantageously without restricting braking and steering capabilities of the targeted vehicle so that a driver of the targeted vehicle can safely maneuver the targeted vehicle to an area remote to oncoming traffic.

The second controller wireless mechanism preferably includes a transceiver embedded within an antenna system of the targeted vehicle, a vehicle identification module housed within the second controller, and a data signal interface for communicating the inquiry and deactivation signals to the vehicle identification module. Such a second controller wireless mechanism preferably further includes a vehicle operations controller electrically mated to the vehicle identification module and a timer control module operably connected to the vehicle operations controller. The timer control module is responsive to a control signal transmitted by the vehicle operations controller for advantageously and effectively inhibiting a driver of the targeted vehicle from accelerating after the deactivation signal has been received by the second controller. A user interface may be electrically mated to the vehicle operations controller for allowing the driver to manually override the deactivation signal during emergency situations.

The velocity controlling mechanism preferably includes a battery power supply source, a starter coil, and a communications switch for linking the battery power supply source to the starter coil. Such a communications switch is selectively adaptable between open and closed positions for allowing and prohibiting the driver to operate the targeted vehicle from a non-operating mode. A response signal is generated and transmitted to the first controller for providing a law enforcement officer the vehicle identification number unique to the targeted vehicle. The system further includes a remotely located service provider including a centralized database containing authorization codes unique to vehicle identification numbers associated with civilian vehicles.

A dedicated communication link securely transmits confidential data streams to the service provider. Such a communications link includes a wireless network, and the wireless network includes a cellular telephone network.

The present system further includes a request signal containing an embedded vehicle identification number associated with the targeted vehicle, an authorization signal including one of the authorization codes embedded therein, and a deactivation signal including the one authorization code.

During operating conditions, the second controller generates and sends the response signal to the first controller, and the first controller generates and transmits the request signal over the dedicated communications link to the service provider after receiving the response signal from the second controller. Such a service provider subsequently generates an authorization signal based upon the request signal and transmits the authorization signal over the dedicated communication link such that the law enforcement officer can advantageously quickly and efficiently obtain the authorization code during a fast-speed pursuit. Finally, the first controller wirelessly transmits the deactivation signal to the targeted vehicle for effectively causing the second controller to disable selected operating characteristics of the targeted vehicle in such a manner that the targeted vehicle can advantageously be quickly and safely subdued by the law enforcement officer.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a schematic block diagram showing a remotely operable vehicle disabling system, in accordance with the present invention;

FIG. 2 is a schematic block diagram of the first controller wireless mechanism shown in FIG. 1;

FIG. 3 is a schematic block diagram of the second controller wireless mechanism shown in FIG. 1;

FIG. 4 is a schematic block diagram outlining the operational steps of the system shown in FIG. 1;

FIG. 5 is a schematic block diagram of the user interface shown in FIG. 2;

FIG. 6 is a schematic block diagram of the vehicle velocity controlling mechanism shown in FIG. 3; and

FIG. 7 is a schematic block diagram showing the wireless communication network of the system shown in FIG. 1.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

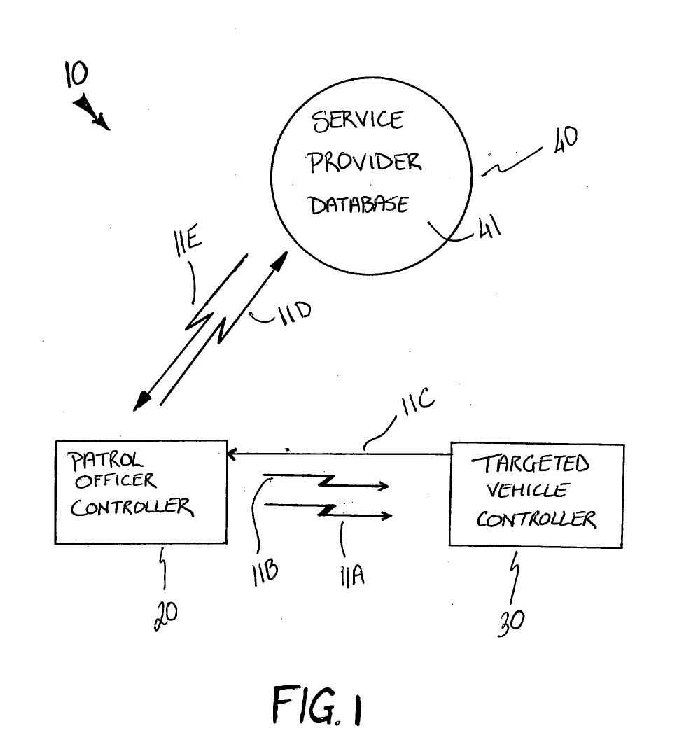

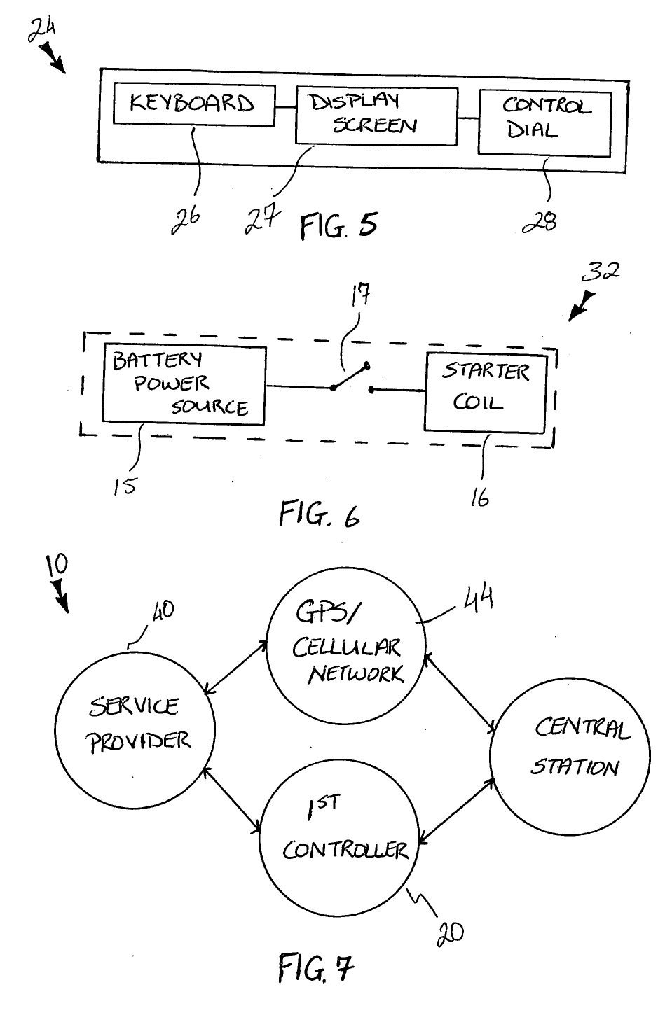

The system of this invention is referred to generally in FIGS. 1-7 by the reference numeral 10 and is intended to provide a remotely operable vehicle disabling system. It should be understood that the system 10 may be used to disable many different types of vehicles, such as motorcycles and semi-trucks, and should not be limited in use to only motor vehicles.

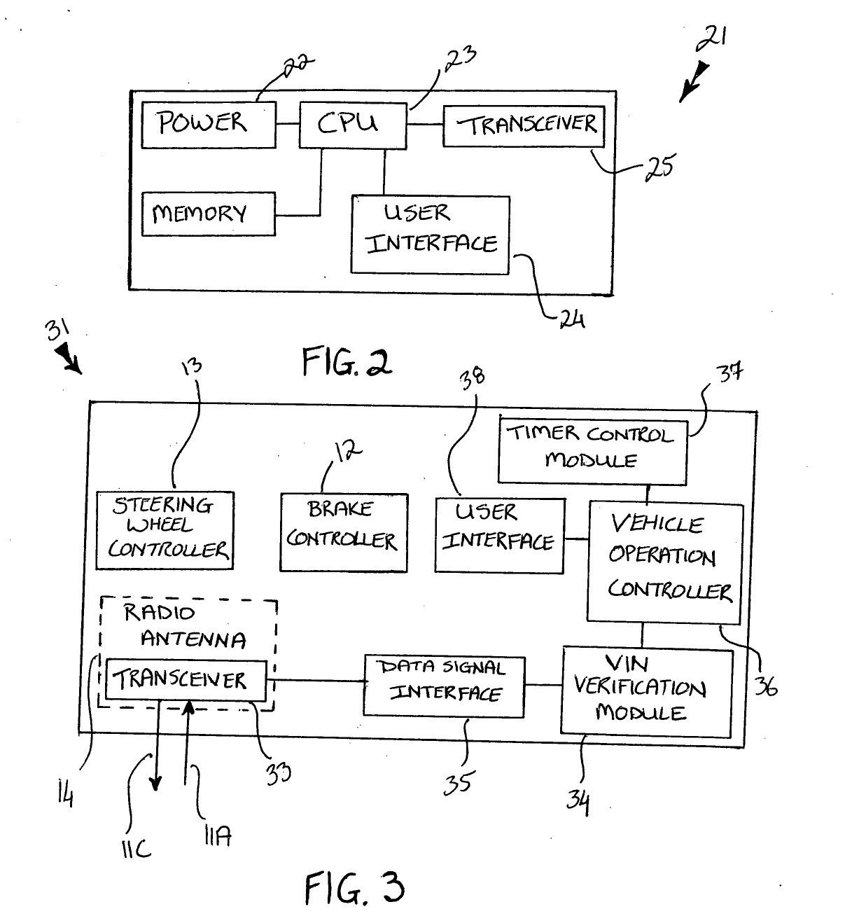

Referring initially to FIGS. 1 and 2, the system 10 includes a first controller 20 housed within a law enforcement vehicle (not shown). Such a first controller 20 includes a first wireless mechanism 21 for determining a vehicle identification number unique to the targeted vehicle (not shown) when the targeted vehicle enters a predetermined proximity surrounding the first controller 20. The first wireless mechanism 21 generates and transmits a short range inquiry signal 11A to the targeted vehicle for effectively requesting the vehicle identification number, such that the proper vehicle is targeted by the first controller 20.

An object, such as a targeted vehicle, contains a second wireless controller 30, as shown in FIG. 1. The second wireless controller 30 includes a wireless mechanism 31 most likely hidden somewhere in the automobile, and it may even be integrated into the body or the engine. For example, the system 10 may be integrated into the automobile's Primary Computer Module. The system 10 can either be connected to the power source associated with the object, such as the automobile battery, or it may have a self-contained power source or sources, as further discussed below.

The second wireless controller 30 receives a page from a first wireless mechanism 21 preferably initiated by law enforcement personnel located within a law enforcement vehicle. For example, the page request can be initiated by a driver of law enforcement vehicle or a passenger seated within the vehicle. During a fast-speed pursuit, the law enforcement vehicle may also instruct a police station or fire station to locate any and all vehicles which are traveling through the detection zone and have a vehicle identification number unique to the targeted vehicle. Based upon a response from the second wireless mechanism 31 housed within the targeted vehicle, the law enforcement officer requests an authorization code from a service provider. The service provider's response is to send a page to the law enforcement vehicle or to a central monitoring station so that local or state highway control personnel can remotely monitor the status of one or more targeted vehicles.

The page need not originate in the paging satellite but can originate in any system capable of sending out pages. For example, a cellular network may be capable of sending out pages and could be used instead of the paging satellite. Further, the system need not use a page to communicate between the service provider and the first wireless controller 20 but can use any system that allows the service provider to uniquely address the first wireless controller 20 via a broadcast signal. For example, very low frequency signals or HF radio signals could be used to communicate between the service provider and the first wireless controller 20.

When the central station receives the page, it determines the vehicle location and direction of movement by accessing the signals of the GPS system, which comprises a plurality of satellites broadcasting signals which can be used to determine an object's location heading anywhere on the earth, as well known in the industry. The central station then formats the location information into a cellular telemetry stream and transmits it via the cellular system's telemetry channels. Advantageously, a policeman or fireman, for example, can manually activate and deactivate the system 10 via the hand-operable first controller, as described hereinbelow.

In the AMPS (Advanced Mobile Phone System) cellular system, which is the analog cellular system used in the United States, each cellular base station has 832 channels. The 832 channels are divided among at least two competing cellular carriers. Each cellular carrier uses 21 of the 416 channels to carrying control signals. Each control channel includes a Forward Control Channel (FOCC) and a Reverse Control Channel (RECC).

The cellular base station uses the FOCC to send information to cellular telephones and the cellular telephones send information back to the cellular base station via the RECC. The FOCC and RECC are used to establish a cellular telephone call through a local switch. Once the cellular telephone call is established, the call is moved to one of the non-control channels and the released control channel is made available to establish other cellular telephone calls.

The cellular base station broadcasts a System Identification (“SID”) signal, which identifies the cellular system to cellular telephones receiving it. When a cellular telephone is turned on, it compares the SID signal it receives against a SID stored within the telephone, which identifies the cellular telephone's home system. If the received SID is not the same as the stored SID, the cellular telephone is “roaming” and the “roam” indicator on the telephone is illuminated.

Subsequently, the cellular telephone transmits its identity to the cellular base station via the RECC. The RECC transmission includes the telephone's Mobile Identification Number (“MIN”), which is a unique 10-digit number (analogous to a telephone number including an area code) that is programmed into the cellular telephone. The first six digits of the MIN identify the cellular telephone's home system. The RECC also includes an Electronic Serial Number (“ESN”), a unique 32-bit serial number permanently stored in the cellular telephone which uniquely identifies the cellular telephone. The cellular base station will receive the MIN and ESN through the RECC and determine that the MIN does not correspond to a local number. Using the MIN, the cellular base station will determine the home system for the cellular telephone and send a validation signal to that system. The cellular local switches in the United States are interconnected through the Intersystem Signaling Network, IS-41, which allows them to send and receive validation information.

The validation signal, known under IS-41 as a Registration/Notification Invoke (REGNOT) message, includes the cellular telephone's MIN and ESN. The REGNOT message also includes the identity of the cellular base station sending the message. The cellular telephone's home system will respond with a Registration/Notification Return Result (REGNOT) message. In the REGNOT message, the cellular telephone's home system will either indicate that it will take financial responsibility for calls made by the cellular telephone or it will refuse to validate the cellular telephone. If validation occurs, a subsequent exchange of messages establishes the features (such as call forwarding) available to the cellular telephone.

The validation process just described uses the cellular system's control channels. Again, once a cellular telephone call is initiated the control channel that was used to set up the call is released for other purposes.

Returning to FIG. 1, upon receipt of the inquiry signal from the first controller, the second wireless controller 30 determines the vehicle identification number of targeted vehicle using the vehicle identification number module housed within the targeted vehicle. The first wireless controller 20 then formats the location and movement information into the payload portion of a cellular RECC signal and transmits it to a local cellular base station. The MIN portion of the RECC signal may contain a unique MIN or it may be a MIN that is common to all triggerable location-reporting system serviced by a common service provider. Alternatively, the MIN may be different for each system. The service provider can now communicate the location of the vehicle to the control station, law enforcement vehicle, or any other regulatory agency.

Referring to FIG. 2, the first controller wireless mechanism 21 includes an internal power supply source 22, a processor 23 electrically coupled to the internal power supply source 22, a user interface 24 electrically coupled to the processor 23, and a transceiver 25 electrically coupled to the processor 23. Such a user interface 24 also includes a keyboard 26, a display screen 27, and a control dial 28 for allowing the pursuing law enforcement officer to enter the vehicle identification number, such that the correct authorization code is obtained.

Referring to FIGS. 1, 3 and 6, a second controller 30 is housed within the targeted vehicle. Of course, such a second controller 30 may be placed in various inconspicuous areas of the vehicle, such that tampering therewith is advantageously prevented, as is obvious to a person of ordinary skill in the art. Advantageously, the second controller 30 may be incorporated into existing, as well as, newly manufactured automobiles. Such a second controller 30 includes a wireless mechanism 31 for effectively communicating with the first controller 20 and further includes a mechanism 32 for controlling a velocity of the targeted vehicle advantageously without restricting the braking 12 and steering 13 capabilities of the targeted vehicle so that a driver of the targeted vehicle can safely maneuver the targeted vehicle to an area remote to oncoming traffic and pedestrians.

Referring to FIG. 3, the second controller wireless mechanism 31 includes a transceiver 33 embedded within an antenna system 14 of the targeted vehicle, a vehicle identification module 34 housed within the second controller 30, and a data signal interface 35 for communicating the inquiry 11A and deactivation 11B signals to the vehicle identification module 34. Such a second controller wireless mechanism 31 further includes a vehicle operations controller 36 electrically mated to the vehicle identification module 34 and a timer control module 37 operably connected to the vehicle operations controller 36. The timer control module 37 is responsive to a control signal transmitted by the vehicle operations controller 36 for advantageously and effectively inhibiting a driver of the targeted vehicle from accelerating after the deactivation signal 11B has been received by the second controller 30, thus preventing the driver from fleeing from a pursuing law enforcement officer. A user interface 38 is electrically mated to the vehicle operations controller 36 for allowing the driver to manually override the deactivation signal 11B during emergency situations.

Referring to FIG. 6, the velocity controlling mechanism 32 includes a battery power supply source 15, a starter coil 16, and a communications switch 17 for linking the battery power supply source 15 to the starter coil 16. Such a communications switch 17 is selectively adaptable between open and closed positions for allowing and prohibiting the driver to operate the targeted vehicle from a non-operating mode. The communication switch 17 is vital for the proper functioning of the system 10, since positioning the switch 17 to an open position effectively causes the interruption in the vehicle's acceleration capabilities.

Referring to FIGS. 1 and 3, a response signal 11C is generated and transmitted to the first controller 20 for providing a law enforcement officer the vehicle identification number unique to the targeted vehicle. Such a response signal 11C is important to the proper functioning of the system 10 by ensuring that the officer targets the correct vehicle with the first controller 20.

Referring to FIGS. 1 and 7, the system further includes a remotely located service provider 40 including a centralized database 41 containing authorization codes unique to vehicle identification numbers associated with civilian vehicles.

Referring to FIG. 7, a dedicated communication link securely transmits confidential data streams to the service provider 40. Such a communications link includes a wireless network, and the wireless network includes a cellular telephone network 44.

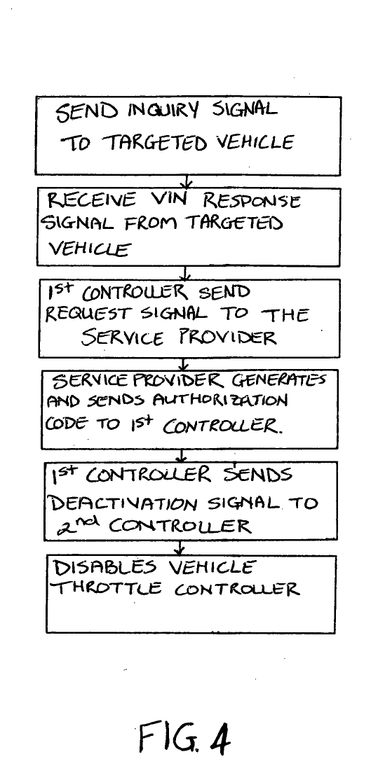

Referring to FIGS. 1 and 4, the present system 10 further includes a request signal 11D containing an embedded vehicle identification number associated with the targeted vehicle, an authorization signal 11E including one of the authorization codes embedded therein, and a deactivation signal 11B including the one authorization code.

Referring to FIG. 4, during operating conditions, the second controller 30 generates and sends the response signal 11C to the first controller 20, and the first controller 20 generates and transmits the request signal 11D over the dedicated communications link to the service provider 40 after receiving the response signal 11C from the second controller 30. Such a service provider 50 subsequently generates an authorization signal 11E based upon the request signal 11D and transmits the authorization signal 11E over the dedicated communication link such that the law enforcement officer can advantageously quickly and efficiently obtain the one authorization code during a fast-speed pursuit.

Finally, the first controller 20 wirelessly transmits the deactivation signal 11B to the targeted vehicle for effectively causing the second controller 30 to disable selected operating characteristics of the targeted vehicle in such a manner that the targeted vehicle can advantageously be quickly and safely subdued by the law enforcement officer. This feature advantageously eliminates the possibility of a high-speed chase, while still allowing the suspect to maintain control over their vehicle and bring it to a standstill in an orderly and safe manner. Unfortunately, other vehicle disabling systems do not allow for such an orderly stopping of a car, and even put the driver, the pursuing officer(s), other motorists and pedestrians at further risk.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A vehicle control system for allowing law enforcement personnel to remotely disable a targeted vehicle, said vehicle control system comprising:
a first controller housed within a law enforcement vehicle, said first controller comprising wireless means for determining a vehicle identification number unique to the targeted vehicle when the targeted vehicle enters a predetermined proximity surrounding said first controller, said wireless means generating and transmitting a short range inquiry signal to the targeted vehicle for requesting the vehicle identification number;
a second controller housed within the targeted vehicle, said second controller comprising wireless means for communicating with said first controller and further comprising means for controlling a velocity of the targeted vehicle without restricting braking and steering capabilities of the targeted vehicle so that a driver of the targeted vehicle can safely maneuver the targeted vehicle to an area remote to oncoming traffic;
a response signal generated and transmitted to said first controller for providing a law enforcement officer the vehicle identification number unique to the targeted vehicle;
a remotely located service provider comprising a centralized database containing authorization codes unique to vehicle identification numbers associated with civilian vehicles;
a dedicated communication link for securely transmitting confidential data streams to said service provider;
a request signal containing an embedded vehicle identification number associated with the targeted vehicle;
an authorization signal including one said authorization codes embedded therein; and
a deactivation signal including said one authorization code;
wherein said second controller generates and sends said response signal to said first controller, said first controller generating and transmitting said request signal over said dedicated communications link to said service provider after receiving said response signal from said second controller, said service provider generating an authorization signal based upon said request signal and transmitting said authorization signal over said dedicated communication link such that the law enforcement officer can quickly and efficiently obtain said one authorization code during a fast-speed pursuit, said first controller wirelessly transmitting said deactivation signal to the targeted vehicle for causing said second controller to disable selected operating characteristics of the targeted vehicle in such a manner that the targeted vehicle can be quickly and safely subdued by the law enforcement officer.

2. The vehicle control system of claim 1, wherein said first controller wireless means comprises:
an internal power supply source;
a processor electrically coupled to said internal power supply source;
a user interface electrically coupled to said processor; and
a transceiver electrically coupled to said processor.

3. The vehicle control system of claim 1, wherein said second controller wireless means comprises:
a transceiver embedded within an antenna system of the targeted vehicle;
a vehicle identification module housed within said second controller;
a data signal interface for communicating said inquiry and deactivation signals to said vehicle identification module;
a vehicle operations controller electrically mated to said vehicle identification module;
a timer control module operably connected to said vehicle operations controller, said timer control module being responsive to a control signal transmitted by said vehicle operations controller for effectively inhibiting a driver of the targeted vehicle from accelerating after said deactivation signal has been received by said second controller; and
a user interface electrically mated to said vehicle operations controller for allowing the driver to manually override said deactivation signal during emergency situations.

4. The vehicle control system of claim 1, wherein said velocity controlling means comprises:
a battery power supply source;
a starter coil; and
a communications switch for linking said battery power supply source to said starter coil, said communications switch being selectively adaptable between open and closed positions for allowing and prohibiting the driver to operate the targeted vehicle from a non-operating mode.

5. A vehicle control system for allowing law enforcement personnel to remotely disable a targeted vehicle, said vehicle control system comprising:
a first controller housed within a law enforcement vehicle, said first controller comprising wireless means for determining a vehicle identification number unique to the targeted vehicle when the targeted vehicle enters a predetermined proximity surrounding said first controller, said wireless means generating and transmitting a short range inquiry signal to the targeted vehicle for requesting the vehicle identification number;
a second controller housed within the targeted vehicle, said second controller comprising wireless means for communicating with said first controller and further comprising means for controlling a velocity of the targeted vehicle without restricting braking and steering capabilities of the targeted vehicle so that a driver of the targeted vehicle can safely maneuver the targeted vehicle to an area remote to oncoming traffic;
a response signal generated and transmitted to said first controller for providing a law enforcement officer the vehicle identification number unique to the targeted vehicle;
a remotely located service provider comprising a centralized database including containing authorization codes unique to vehicle identification numbers associated within civilian vehicles;
a dedicated communication link for securely transmitting confidential data streams to said service provider, wherein said communications link comprises a wireless network;
a request signal containing an embedded vehicle identification number associated with the targeted vehicle;
an authorization signal including one said authorization codes embedded therein; and
a deactivation signal including said one authorization code;
wherein said second controller generates and sends said response signal to said first controller, said first controller generating and transmitting said request signal over said dedicated communications link to said service provider after receiving said response signal from said second controller, said service provider generating an authorization signal based upon said request signal and transmitting said authorization signal over said dedicated communication link such that the law enforcement officer can quickly and efficiently obtain said one authorization code during a fast-speed pursuit, said first controller wirelessly transmitting said deactivation signal to the targeted vehicle for causing said second controller to disable selected operating characteristics of the targeted vehicle in such a manner that the targeted vehicle can be quickly and safely subdued by the law enforcement officer.

6. The vehicle control system of claim 5, wherein said first controller wireless means comprises:
an internal power supply source;
a processor electrically coupled to said internal power supply source;
a user interface electrically coupled to said processor; and
a transceiver electrically coupled to said processor.

7. The vehicle control system of claim 5, wherein said second controller wireless means comprises:
a transceiver embedded within an antenna system of the targeted vehicle;
a vehicle identification module housed within said second controller;
a data signal interface for communicating said inquiry and deactivation signals to said vehicle identification module;
a vehicle operations controller electrically mated to said vehicle identification module;
a timer control module operably connected to said vehicle operations controller, said timer control module being responsive to a control signal transmitted by said vehicle operations controller for effectively inhibiting a driver of the targeted vehicle from accelerating after said deactivation signal has been received by said second controller; and
a user interface electrically mated to said vehicle operations controller for allowing the driver to manually override said deactivation signal during emergency situations.

8. The vehicle control system of claim 5, wherein said velocity controlling means comprises:
a battery power supply source;
a starter coil; and
a communications switch for linking said battery power supply source to said starter coil, said communications switch being selectively adaptable between open and closed positions for allowing and prohibiting the driver to operate the targeted vehicle from a non-operating mode.

9. A vehicle control system for allowing law enforcement personnel to remotely disable a targeted vehicle, said vehicle control system comprising:
a first controller housed within a law enforcement vehicle, said first controller comprising wireless means for determining a vehicle identification number unique to the targeted vehicle when the targeted vehicle enters a predetermined proximity surrounding said first controller, said wireless means generating and transmitting a short range inquiry signal to the targeted vehicle for requesting the vehicle identification number;
a second controller housed within the targeted vehicle, said second controller comprising wireless means for communicating with said first controller and further comprising means for controlling a velocity of the targeted vehicle without restricting braking and steering capabilities of the targeted vehicle so that a driver of the targeted vehicle can safely maneuver the targeted vehicle to an area remote to oncoming traffic;
a response signal generated and transmitted to said first controller for providing a law enforcement officer the vehicle identification number unique to the targeted vehicle;
a remotely located service provider comprising a centralized database including containing authorization codes unique to vehicle identification numbers associated within civilian vehicles;
a dedicated communication link for securely transmitting confidential data streams to said service provider, wherein said wireless network comprises a cellular telephone network;
a request signal containing an embedded vehicle identification number associated with the targeted vehicle;
an authorization signal including one said authorization codes embedded therein; and
a deactivation signal including said one authorization code;
wherein said second controller generates and sends said response signal to said first controller, said first controller generating and transmitting said request signal over said dedicated communications link to said service provider after receiving said response signal from said second controller, said service provider generating an authorization signal based upon said request signal and transmitting said authorization signal over said dedicated communication link such that the law enforcement officer can quickly and efficiently obtain said one authorization code during a fast-speed pursuit, said first controller wirelessly transmitting said deactivation signal to the targeted vehicle for causing said second controller to disable selected operating characteristics of the targeted vehicle in such a manner that the targeted vehicle can be quickly and safely subdued by the law enforcement officer.

10. The vehicle control system of claim 9, wherein said first controller wireless means comprises:
an internal power supply source;
a processor electrically coupled to said internal power supply source;
a user interface electrically coupled to said processor; and
a transceiver electrically coupled to said processor.

11. The vehicle control system of claim 9, wherein said second controller wireless means comprises:
a transceiver embedded within an antenna system of the targeted vehicle;
a vehicle identification module housed within said second controller;
a data signal interface for communicating said inquiry and deactivation signals to said vehicle identification module;
a vehicle operations controller electrically mated to said vehicle identification module;
a timer control module operably connected to said vehicle operations controller, said timer control module being responsive to a control signal transmitted by said vehicle operations controller for effectively inhibiting a driver of the targeted vehicle from accelerating after said deactivation signal has been received by said second controller; and
a user interface electrically mated to said vehicle operations controller for allowing the driver to manually override said deactivation signal during emergency situations.

12. The vehicle control system of claim 9, wherein said velocity controlling means comprises:
a battery power supply source;
a starter coil; and
a communications switch for linking said battery power supply source to said starter coil, said communications switch being selectively adaptable between open and closed positions for allowing and prohibiting the driver to operate the targeted vehicle from a non-operating mode.
